(19) United States
(12) Patent Application Publication
(10) Pub. No.: US 2024/0390856 A1
(43) Pub. Date: Nov. 28, 2024

(54) METHOD FOR MANUFACTURING MULTILAYERED ION EXCHANGE MEMBRANE WITH RECTIFYING PROPERTIES, AND MULTILAYERED ION EXCHANGE MEMBRANE MANUFACTURED THEREBY

(71) Applicant: NextE&M Co.,Ltd, Incheon (KR)

(72) Inventors: Ki Woon CHOI, Incheon (KR); Jae Hoon JUNG, Incheon (KR)

(73) Assignee: NextE&M Co.,Ltd, Incheon (KR)

(21) Appl. No.: 18/503,627

(22) Filed: Nov. 7, 2023

(30) Foreign Application Priority Data
May 25, 2023 (KR) 10-2023-0067523

(51) Int. Cl. B01D 61/48; B01D 67/00; B01D 69/02

(52) U.S. Cl. CPC B01D 61/48; B01D 67/0088; B01D 69/02; B01D 2323/21813; B01D 2323/21819; B01D 2325/42

(57) ABSTRACT

The present disclosure provides a method for manufacturing a multilayered ion exchange membrane with rectifying properties and to a multi-layered ion exchange membrane manufactured thereby. More specifically, the present disclosure provides a method for manufacturing a multilayered ion exchange membrane, and a multilayered ion exchange membrane manufactured thereby, the method including a step of integrally forming a coating layer designed to have a fewer number of ion channels on a base layer having a large number of ion channels, thereby preventing scale generation even under a reverse polarity condition, resulting in improvement in ion exchange efficiency. The method effectively controls the asymmetry of the density (number) of ion channels so that the produced ion exchange membrane can have both the ion selectivity and rectifying properties, without using complicated process of, for example, changing the geometric size of the ion channels or the charge distribution inside the ion channels.

### CROSS REFERENCE TO RELATED APPLICATION

The present application claims priority to Korean Patent Application No. 10-2023-0067523, filed May 25, 2023, the entire contents of which is incorporated herein by reference for all purposes.

### FIELD

The present disclosure relates to a method for manufacturing a multilayered ion exchange membrane with rectifying properties and to a multi-layered ion exchange membrane manufactured thereby.

### BACKGROUND

An ion exchange membrane started with Oswald's discovery of a separation membrane with ion selectivity in 1890 and understanding of the Donnan exclusion phenomenon in 1930, which is a selective transmission phenomenon of ions due to ionic bonding of immobile ions in an ion exchange membrane in an electrolyte solution.

Ion exchange membranes are mainly made of specific synthetic polymer resins known as ion exchange resins. The water and ion channels formed by hydrophilic functional groups with internal charges are as small as or smaller than a few nanometers, and these ion channels are connected to form a complex three-dimensional network structure. Since the ion channels have extremely small sizes, typical commercially available ion exchange membranes generally have an ion selectivity of 90% or more.

The ion exchange membranes are divided into cation exchange membranes and anion exchange membranes depending on the functional group of the membrane. Since the cation exchange membranes have negatively charged functional groups such as —SO₃, —COO, —PO₃²⁻, —PO₃H, and —C₆H₄O on the surface thereof, they block anions and allow selective transmission of cations. Meanwhile, the anion exchange membranes have positive functional groups such as —NH₃⁺, —NRH₂⁺, —NR₂H⁺, —NR₃⁺, —PR₃⁺, and —SR²⁺ and allows selective transmission of anions.

The ion exchange membranes have had various applications such as electrical desalination technology, acid/alkali production, removal of heavy metals from industrial wastewater, desalination of seawater, production of ultrapure water in the semiconductor industry, production of edible salt from seawater, recovery of organic acids and amino acids in the fermentation industry, etc. With the expansion of the range of applications of the ion exchange membranes beyond the existing industrial fields, ion exchange membranes with new functions and characteristics are required.

As mentioned above, ion exchange membranes are used a key component that determines performance and cost in the fields that have recently attracted much attention, such as membrane capacitive seawater desalination, reverse electric dialysis power generation, fuel cells, and renewable energy sources such as redox flow batteries. However, their commercialization in related industries is hindered due to their high price, membrane resistance, and low mechanical, chemical, and thermal durability.

In general, ion exchange membranes are manufactured by phase separation of polymer electrolytes. That is, at the molecular level, a hydrophilic region and a hydrophobic region composed of negatively or positively charged functional groups exist in a state of fine phase separation. In the presence of water, the hydrophobic region serves as the framework of the ion exchange membrane, and ion exchange transfer is known to occur through the hydrophilic region called the ion domain, which is connected to a channel of about 1 nm which is crowded with the hydrophilic groups. Here, the greater the number of channels that serve as ion passages and the shorter their length, the smoother ion exchange transfer occurs, and the ionic conductivity can be increased.

Conventional ion exchange membranes basically have bidirectional ion conductivity that allows ions to move from left to right or from right to left via the membrane, so when such ion exchange membranes are applied to seawater desalination facilities as they are, in the reverse polarity state in which the positive and negative electrodes are switched, sodium ions moving in the reverse direction stick to the electrode and precipitate on the electrode, resulting in generation of scale.

In this case, the efficiency of the seawater desalination facility is reduced due to the scale. Therefore, the operation of the facility must be stopped, and the scale must be removed periodically. In severe cases, the ion exchange membrane is required to be replaced, which not only reduces ion exchange efficiency, but also brings about several problems such as an increase in maintenance costs.

Specifically, the scale is a substance that causes fouling and is generated when dissolved divalent cations such as Ca²⁺ and MG²⁺ and divalent anions such as SO₄²⁻ and CO₃²⁻ combine and attach when the cations and anions are present in excessive concentration on the membrane surface. The generated scale deteriorates the function of the membrane. Although the scale can be removed by chemical cleaning, the chemical cleaning generally causes damage to the membrane and deterioration of performance of the membrane.

Therefore, to prevent the movement of ions causing scale in the reverse direction, there was an attempt to develop a functional membrane specialized for ion rectification (hereinafter referred to as an “ion rectifying film”) that allow ions to flow in only one direction like a semiconductor diode element. However, the ion rectifying membrane had a problem that complicated processing for changing the geometric size of ion channels or the distribution of internal charges in the ion channels are required. Moreover, in the process of changing the geometric size of the ion channels or causing structural change such as the charge distribution, the ion selectivity, which the ion exchange membrane must basically have, was relatively significantly reduced.

### SUMMARY

One embodiment of the present disclosure provides a method for manufacturing a multilayered ion exchange membrane with rectifying properties comprising: (a) forming a base layer having n ion channels inside an ion exchange resin comprising at least one of a fluorine-based polymer, a hydrocarbon-based polymer, or a hydrocarbon-based polymer partially substituted with fluorine; (b) preparing a coating solution configured such that an ionomer and a mixture are uniformly dispersed in a solvent by blending the ionomer, the mixture, and the solvent in a predetermined ratio, wherein the ionomer comprises at least one of a fluorine-based polymer, a hydrocarbon-based polymer, or a hydrocarbon-based polymer partially substituted with fluorine, and the mixture suppresses creation of ion channels in the ionomer when mixed with the ionomer; (c) forming at least one coating layer by applying the coating solution obtained in the step b on the base layer formed in the step a; and (d) imparting rectifying properties of enabling ions to more easily flow in a specific direction by causing m ion channels to be formed in the coating layer in a process of removing the solvent through heat drying so that the ions are made to move from the base layer provided with a larger number of ion channels to the coating layer provided with a smaller number of ion channels, wherein the n is greater than the m.

The present disclosure provides a solution for the problems occurring in the related art and are intended to provide a method for manufacturing a multilayered ion exchange membrane with rectifying properties and a multi-layered ion exchange membrane manufactured thereby. The method includes a step of integrally forming a coating layer designed to have a fewer number of ion channels on a base layer having a larger number of ion channels, thereby preventing scale generation even under a reverse polarity condition, resulting in improvement in ion exchange efficiency. The method effectively controls the asymmetry of the density (number) of ion channels so that the produced ion exchange membrane can have both the ion selectivity and rectifying properties, without using complicated process of, for example, changing the geometric size of the ion channels or the charge distribution in the ion channels.

To accomplish the objective, according to one embodiment of the present disclosure, there is provided a method of manufacturing an ion exchange membrane for desalination equipment, the ion exchange membrane being configured such that a hydrophilic region composed of negatively or positively charged functional groups and a hydrophobic region exist in a state where microphase separation has occurred, a hydrophobic part serves as the framework of the ion exchange membrane in the presence of water, and ion exchange transfer occurs through a hydrophilic part called an ion domain connected by channels that are several nm in size and in which hydrophilic groups of the ion exchange membrane are crowded. The method includes: (a) forming a base layer with a relatively large number of ion channels in an ion exchange resin including at least one of a fluorine-based polymer, a hydrocarbon-based polymer, or a hydrocarbon-based polymer partially substituted with fluorine; (b) blending an ionomer including at least one of the fluorine-based polymer, the hydrocarbon-based polymer, or the hydrocarbon-based polymer partially substituted with fluorine, and a mixture that suppresses creation of ion channels in the ionomer when mixed with the ionomer, with a solvent in a predetermined ratio to obtain a coating solution in which the ionomer and the mixture are uniformly dispersed in the solvent; (c) applying the coating solution of the step b on the base layer of the step a to form one or more coating layers; and (d) forming a relatively small number of ion channels in the coating layer compared to the ion channels formed in the base layer, in a process of heating and drying the coating layer of the step c to remove the solvent, in which the number of the formed ion channels is in reverse proportion to an added amount of the mixture, thereby imparting rectifying properties of enabling ions to flow more easily in a specific direction, from the relatively large number of ion channels formed in the base layer to the relatively small number of ion channels formed in the coating layer, wherein the coating solution of the step b includes: the ionomer including at least one of hydrocarbon-based polymers including polyphenylenes, polyetheretherketones, polyaryleneethers, polyimides, and polystyrenes, or hydrocarbon-based polymers partially substituted with fluorine; and the mixture including at least one of fluorine-based polymers including polyvinylidene fluoride (PVDF) and polytetrafluoroethylene (PTFE), or or hydrocarbon-based polymers including polysulfone, polyetheretherketone, polyimide, and polystyrene, or hydrocarbon polymers partially substituted with fluorine, wherein the blending produces the coating solution composed of 0% to 10% by weight of the ionomer, 10% to 20% by weight of the mixture, and solvent as the balance, wherein the content of the ionomer is gradually reduced from an initial amount of 10% by weight to approximate 0%, the content of the mixture is gradually increased to converge to a final amount of 20% by weight from an initial amount of 10% by weight in a manner to be in reverse proportion to a reduction in the content of the ionomer, and the solvent is added as the balance. When the ion exchange membrane manufactured in a manner described above is applied to desalination equipment, the imparted rectifying properties prevent generation of scales in a reverse polarity condition.

Additionally, according to one embodiment, the coating solution in the step b may further include a crosslinking agent including at least one of polydiacetylene (PDA), N,N′-methylene bisacrylamide (MBA), ethylene glycol diacrylate (EGDA), divinyl adipate (DVA), bis(2-acryl amido ethyl)disulfide (BAED), benzoyl peroxide (BPO), methylene diphenyl diisocyanate (MDI), and polyethyleneimine (PEI).

Additionally, according to one embodiment, the solvent may include at least one of water, ethanol, methanol, propyl alcohol, acetone, DMF, DMAc, and NMP.

Additionally, according to one embodiment, as a result of the step d, the ratio of the number of the ion channels formed in the base layer to the number of the ion channels formed in the coating layer may be in a range of 10:1 to 100:1.

Additionally, according to one embodiment, in the step c, the coating solution may be first applied to a surface of a round bar, and the bar may then be brought into contact with an upper surface of the base layer and moved forward, so that the coating solution may be transferred from the surface of the bar to the upper surface of the base layer.

Additionally, according to one embodiment, the bar may move forward at a speed of 20 to 100 mm per second while being in contact with the upper surface of the base layer.

Additionally, according to one embodiment, in the step d, the base layer coated with the coating solution may be gradually heated and dried on a hot plate in a temperature range of 15° C. to 300° C. for up to 24 hours.

Additionally, according to one embodiment, the base layer of the step a may further include a film-forming binder including at least one of polyethylene, polypropylene, and polyvinyl chloride.

Additionally, according to one embodiment, the base layer of the step a may further include an inorganic additive including at least one of silica gel, carbon nanotube, aluminum oxide, and glass fiber.

Additionally, according to one embodiment, the base layer of the step a may further include a support film-constituting material including at least one of polypropylene, polyethylene, PVC, PTFE, PVDF, and PET.

Meanwhile, an ion exchange membrane with rectifying properties, according to the present disclosure is an ion exchange membrane for desalination equipment, the ion exchange membrane being configured such that a hydrophilic region composed of negatively or positively charged functional groups and a hydrophobic region exist in a state where microphase separation has occurred, a hydrophobic part serves as the framework of the ion exchange membrane in the presence of water, and ion exchange transfer occurs through a hydrophilic part called an ion domain connected by channels that are several nm in size and in which hydrophilic groups of the ion exchange membrane are crowded, wherein the ion exchange membrane includes: (a) a base layer with a large number of ion channels in an ion exchange resin including at least one of a fluorine-based polymer or a hydrocarbon-based polymer partially substituted with fluorine; and a coating layer formed on the base layer and provided with a small number of ion channels than the ion channels formed in the base layer, wherein the coating layer includes: an ionomer including at least one of hydrocarbon-based polymers including polyphenylenes, polyetheretherketones, polyaryleneethers, polyimides, and polystyrenes, or hydrocarbon-based polymers partially substituted with fluorine; and a mixture that inhibits creation of ion channels in the ionomer when mixed with the ionomer and which includes at least one of fluorine-based polymers including polyvinylidene fluoride (PVDF) and polytetrafluoroethylene (PTFE), or hydrocarbon-based polymers including polysulfone, polyetheretherketone, polyimide, and polystyrene, or hydrocarbon polymers partially substituted with fluorine, wherein the number of the ion channels formed in the coating layer is in reverse proportion to an added amount of the mixture, wherein the blending produces the coating solution composed of 0% to 10% by weight of the ionomer, 10% to 20% by weight of the mixture, and a solvent as the balance, wherein the content of the ionomer is gradually reduced from an initial amount of 10% by weight to approximate 0%, the content of the mixture is gradually increased to converge to a final amount of 20% by weight from an initial amount of 10% by weight in a manner to be in reverse proportion to a reduction in the content of the ionomer, and the solvent is added as the balance. When such an ion exchange membrane is applied to desalination equipment, scale generation in a reverse polarity condition is prevented due to the imparted rectifying properties.

Additionally, according to one embodiment, the mixture includes at least one of fluorine-based polymers including polyvinylidene fluoride (PVDF) and polytetrafluoroethylene (PTFE), hydrocarbon-based polymers including polysulfone, polyetheretherketone, polyimide, and polystyrene, or hydrocarbon-based polymers partially substituted with fluorine.

As described above, the present disclosure provides the effect of improving ion exchange efficiency by preventing the occurrence of scale in a reverse polarity condition by integrally forming a coating layer designed to have a relatively smaller number of ion channels on a base layer having a relatively larger number of ion channels. This has the effect of reducing maintenance costs because there is no need to remove scale or replace ion exchange membranes.

In addition, since it is possible to impart rectifying properties to existing commercial ion rectification membranes by controlling the asymmetry of the density (number) of ion channels rather than using complicated processes of changing the geometric size of ion channels or to change internal charge distribution in ion channels, thereby effectively achieving both the ion selectivity and the rectifying function at the same time.

### BRIEF DESCRIPTION OF THE DRAWINGS

FIG. 1 is a process flowchart of a method of manufacturing a multilayered ion exchange membrane with rectifying properties, according to one embodiment of the present disclosure;

FIGS. 2A and 2B are conceptual diagrams showing ion channels formed in an ion exchange membrane, in which FIG. 2A illustrates a general ion exchange membrane, and FIG. 2B illustrates a multilayered ion exchange membrane with rectifying properties according to the present disclosure;

FIG. 3 is a conceptual diagram illustrating a process of changing the ratio of the number of ion channels in the multilayered ion exchange membrane with rectifying properties according to the present disclosure;

FIGS. 4A and 4B are diagrams illustrating the concentration distribution of ions moved along ion channels at a ratio of 1:9 for the case of FIG. 3, in which FIG. 4A illustrates a cation exchange membrane, and FIG. 4B illustrates an anion exchange membrane;

FIG. 5 is a graph illustrating the current ratio by ion channel ratio for the case of FIG. 3;

FIG. 6 is a flowchart showing step by step the manufacturing method of the multilayered ion exchange membrane with rectifying properties according to the present disclosure; and

FIG. 7 is a graph illustrating the results of evaluation of the rectifying properties of an ion exchange membrane manufactured by the method of the present disclosure.

### DETAILED DESCRIPTION

The terminology used herein is for the purpose of describing particular embodiments only and is not intended to be limiting. As used herein, the singular forms “a”, “an”, and “the” are intended to include plural forms as well unless the context clearly indicates otherwise. It will be further understood that the terms “comprise”, “include”, or “have” when used in this specification specify the presence of stated features, regions, integers, steps, operations, elements, and/or components, but do not preclude the presence or addition of one or more other features, regions, integers, steps, operations, elements, components and/or combinations thereof.

In the specification, unless otherwise defined, all terms including technical and scientific terms used herein have the same meaning as commonly understood by those who are ordinarily skilled in the art to which this disclosure belongs.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

First, the present disclosure discloses a method of manufacturing a multilayered ion exchange membrane with rectifying properties to provide a commercially available ion exchange membrane with ion rectifying properties as well as ion selectivity.

To this end, the present disclosure, provides a method of manufacturing an ion exchange membrane with rectifying properties (herein after, referred to as “rectifying ion exchange membrane”), the method being capable of effectively implementing the ion rectification phenomenon using a simple process, unlike the conventionally known ion rectification membrane manufacturing process, thereby providing ion rectification properties as well as ion selectivity at the level of commercial ion exchange membranes currently used in various industrial fields.

In addition, to exhibit ion rectifying properties, the present disclosure does not use a complicated process of changing the geometric size of ion channels or the charge distribution in ion channels of conventional ion rectification membranes, but uses a method of controlling the asymmetry of the density (number) of ion channels between a base layer and a coating layer in the process of integrally forming, on a base layer having a large number of ion channels, one or more coating layers having a smaller number of ion channels. Thus, the method can produce a multilayered ion exchange membrane having rectifying properties and good ion selectivity.

The present disclosure provides a method of manufacturing a commercially usable rectifying ion exchange membrane by forming ion channels having asymmetric rectification characteristics in the coating layer by adjusting the content ratio of major components of the base layer and the coating layer, i.e., an ion exchange resin that forms ion channels and a mixture that has the function of hindering and suppressing the formation of the ion channels in the ion exchange resin.

Here, the mixture contained in the coating layer has the characteristic of a material that does not play the role of forming ion channels, in contrast to the ion exchange resin. Since the mixture is contained in the coating layer, an area in which ion channels do not exist is formed in proportion to the content of the mixture.

In other words, it hinders and suppresses the formation of ion channels in the coating layer in such a way that the ratio of the area where ion channels are formed by the ion exchange resin is reduced by the content of the mixture included in the coating layer. By utilizing these characteristics, it is possible to adjust the number of ion channels according to the content ratio of the ion exchange resin and the mixture. As such, the manufacturing method of the present disclosure enables high-level rectification characteristics to be realized through precise control of the formation of ion channels.

Hereinafter, with reference to the accompanying drawings, the configuration of a method for manufacturing a multilayered ion exchange membrane with rectifying properties according to an embodiment of the present disclosure will be described in detail.

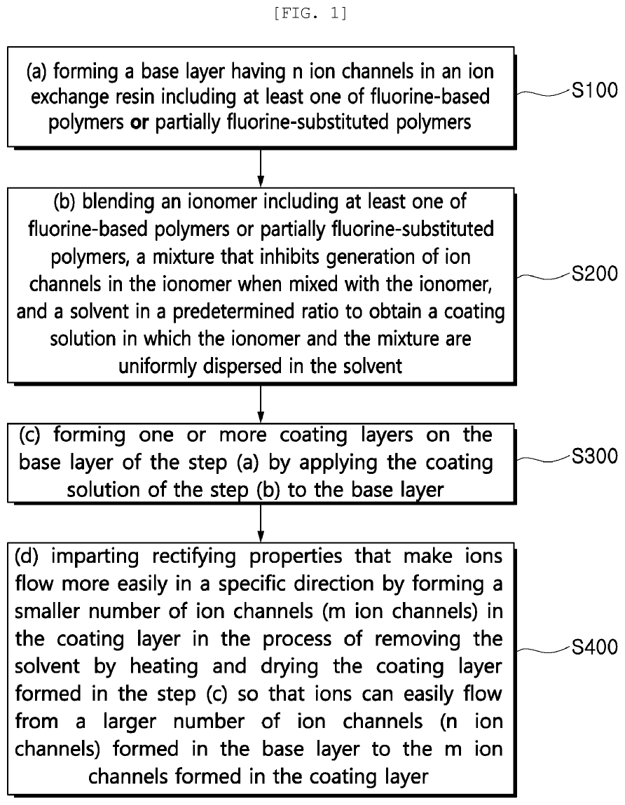

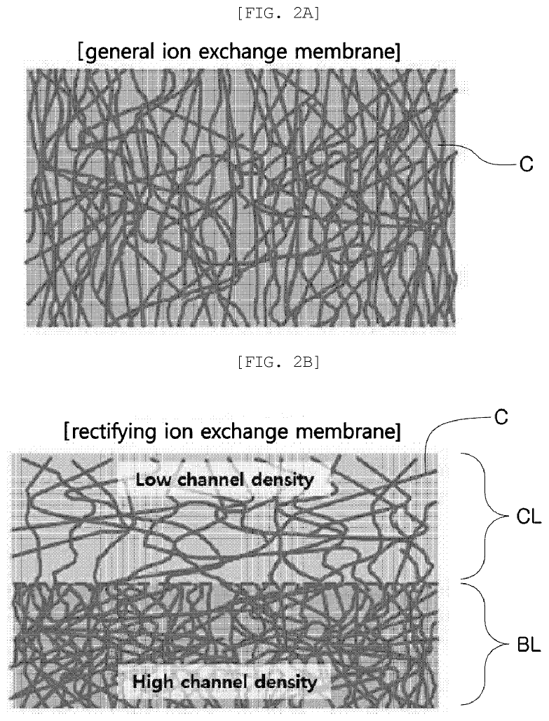

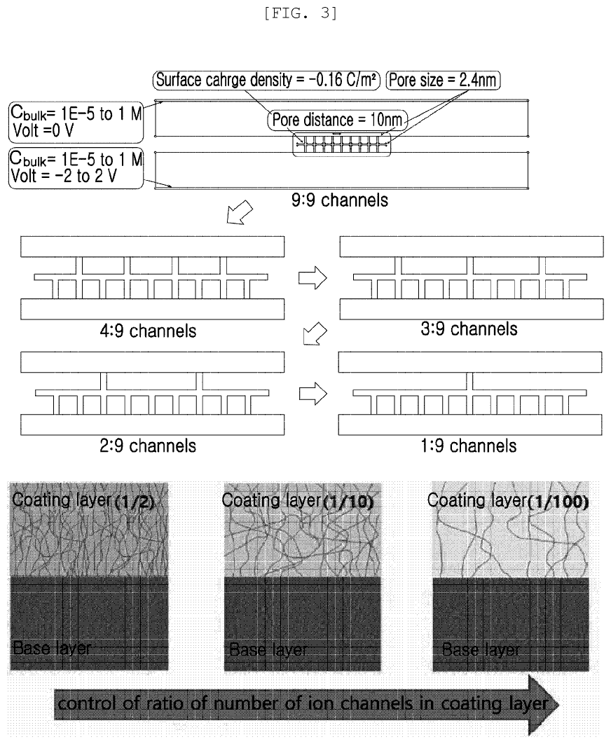

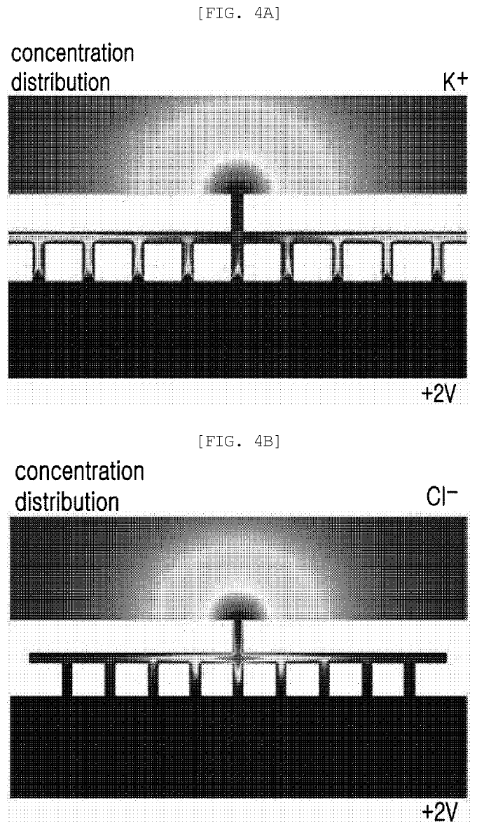

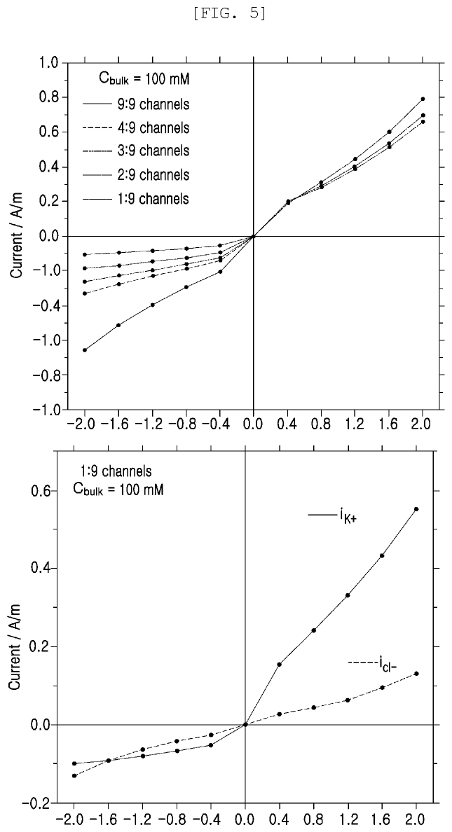

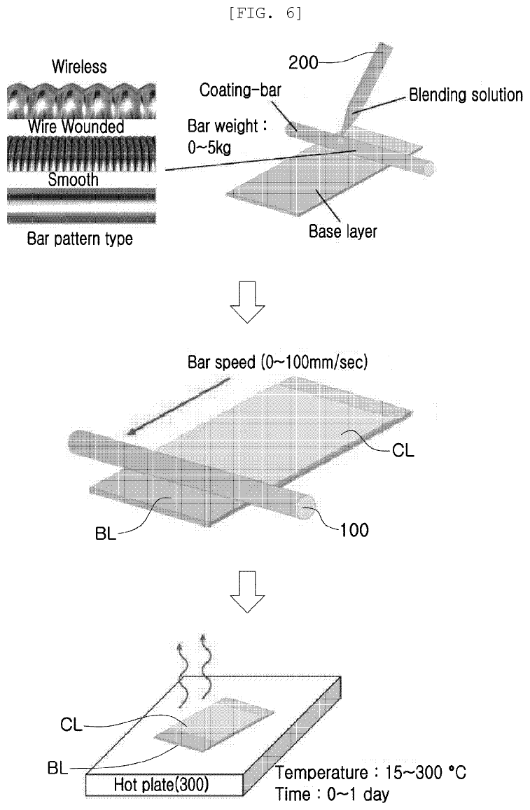

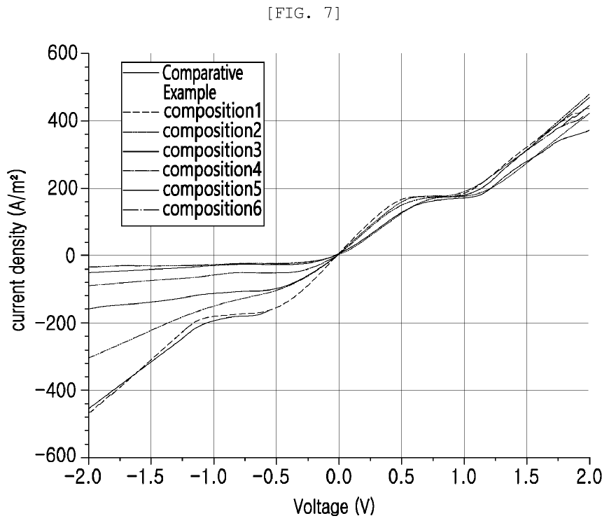

FIG. 1 is a process flowchart of a method of manufacturing a multilayered ion exchange membrane with rectifying properties, according to one embodiment of the present disclosure; FIGS. 2A and 2B are conceptual diagrams showing ion channels formed in an ion exchange membrane, in which FIG. 2A illustrates a general ion exchange membrane, and FIG. 2B illustrates a multilayered ion exchange membrane with rectifying properties according to the present disclosure; FIG. 3 is a conceptual diagram illustrating a process of changing the ratio of the number of ion channels in the multilayered ion exchange membrane with rectifying properties according to the present disclosure; FIGS. 4A and 4B are diagrams illustrating the concentration distribution of ions moved along ion channels at a ratio of 1:9 for the case of FIG. 3, in which FIG. 4A illustrates a cation exchange membrane, and FIG. 4B illustrates an anion exchange membrane; FIG. 5 is a graph illustrating the current ratio by ion channel ratio for the case of FIG. 3; FIG. 6 is a flowchart showing step by step the manufacturing method of the multilayered ion exchange membrane with rectifying properties according to the present disclosure; and FIG. 7 is a graph illustrating the results of evaluation of the rectifying properties of an ion exchange membrane manufactured by the method of the present disclosure.

First, the configuration of one embodiment of the present disclosure will be described with reference to FIGS. 1 to 7, and the following steps may be performed.

Step a: A base layer BL having n ion channels C in an ion exchange resin is formed. The ion exchange resin includes at least one of a fluorine-based polymer, a hydrocarbon-based polymer, or a hydrocarbon-based polymer partially substituted with fluorine (S100).

According to one embodiment, the base layer BL is made of an ion exchange resin including at least one of fluorine-based polymers including perfluorosulfonic acid and perfluorocarboxylic acid, hydrocarbon-based polymers including polyphenylenes, polyetheretherketones, polyaryleneethers, polyimides, and polystyrenes, or hydrocarbon-based polymers partially substituted with fluorine.

For reference, the hydrocarbon polymer partially substituted with fluorine refers to a hydrocarbon polymer partially substituted with fluorine, and is distinguished the general hydrocarbon polymers described above.

Phenylene oxide, phenylene sulfide, and para-phenylene are carbon hydrogen polymers, and are classes classified according to the repeating units that make up the polymers. Therefore, polymers such as phenylene oxide, phenylene sulfide, and para-phenylene are collectively called polyphenylene polymers in which phenylene units linked.

The base layer BL may further include a film-forming binder including at least one of polyethylene, polypropylene, and polyvinyl chloride.

The base layer BL may further include an inorganic additive including at least one of silica gel, carbon nanotube, aluminum oxide, and glass fiber.

The base layer BL may further include a support film-constituting binder including at least one of polypropylene, polyethylene, PVC, PTFE, PVDF, and PET.

Step b: A coating solution configured such that an ionomer and a mixture are uniformly dispersed in a solvent is prepared by blending the ionomer, the mixture, and the solvent in a predetermined ratio. Here, the ionomer includes at least one of a fluorine-based polymer, a hydrocarbon-based polymer, or a hydrocarbon-based polymer partially substituted with fluorine, and the mixture serves to inhibit creation of ion channels in the ionomer when mixed with the ionomer (S200).

According to one embodiment, in this step, the coating solution is prepared by blending 0 to 10 wt % of the ionomer, 10 to 20 wt % of the mixture, and the remaining wt % of the solvent.

More specifically, in the coating solution, the content of the ionomer is gradually reduced from 10 wt % to approximately 0 wt %, the content of the mixture is gradually increased from 10 wt % to 20 wt % in proportion to a reduction in the content of the ionomer, and the solvent accounts for the remaining wt %.

According to one embodiment, the ionomer may be a polymeric compound including at least one of hydrocarbon-based polymers including polyphenylenes, polyetheretherketones, polyaryleneethers, polyimides, and polystyrenes, or hydrocarbon-based polymers partially substituted with fluorine.

The mixture may be a polymeric compound including at least one of fluorine-based polymers including polyvinylidene fluoride (PVDF) and polytetrafluoroethylene (PTFE), hydrocarbon-based polymers including polysulfone, polyetheretherketone, polyimide, and polystyrene, or hydrocarbon-based polymers partially substituted with fluorine.

Additionally, according to one embodiment, the coating solution in the step b may further include a crosslinking agent that is at least one of polydiacetylene (PDA), N,N′-methylene bisacrylamide (MBA), ethylene glycol diacrylate (EGDA), divinyl adipate (DVA), bis(2-acryl amido ethyl)disulfide (BAED), benzoyl peroxide (BPO), methylene diphenyl diisocyanate (MDI), and polyethyleneimine (PEI).

Additionally, according to one embodiment, the solvent may be at least one of water, ethanol, methanol, propyl alcohol, acetone, DMF, DMAc, NMP, and various mixtures thereof.

Step c: The coating solution prepared in the step b is applied to the base layer BL formed in the step a to form at least one coating layer CL on the base layer BL (S300).

An apparatus for manufacturing a multilayered ion exchange membrane with rectifying properties to perform the steps described above is composed of a coating unit and a drying unit. Referring to FIG. 6, the coating unit includes a coating bar 100 having a round bar shape and a coating solution supply nozzle 200, and the drying unit may be a hot plate 300.

In this step, the coating solution is first applied to the surface of the coating bar 100 having a round bar shape through the coating solution supply nozzle 200, and the coating bar is brought into contact with the upper surface of the base layer BL and is driven to move while being in contact with the base layer BL so that the coating solution on the surface of the coating bar 100 to the upper surface of the base layer BL.

The coating bar 100 moves at a speed of 20 mm/sec while being in contact with the upper surface of the base layer BL.

According to one embodiment, as the ionomer, an ion exchange resin of the same material as that of the base layer BL may be used. The coating solution in which the ionomer, the mixture, and the solvent are mixed may be applied to the base layer BL to form the coating layer CL. By this method, it is possible to control the rectification characteristic of the ion exchange membrane of the present disclosure by adjusting the ratio of the number of ion channels formed in the base layer BL and the number of ion channels formed in the coating layer CL.

The weight percentage of the solute (ionomer+mixture) forming the coating layer CL in the blended coating solution can be up to 30 wt % or less based on 100 wt % of the total coating solution, especially the coating solution excluding the solvent. In the solution excluding the solvent (i.e., coating layer that is dried as the solvent is evaporated). When the content of the ionomer is 40 wt % or less and the content of the mixture is 60% or more, that is, when the content of the mixture is higher than the content of the ionomer, the better rectification characteristics can be expressed.

According to one embodiment, in this step, the application of the coating solution was performed by transfer coating using the coating bar 100. The transfer coating process using the coating bar will be described below with reference to FIG. 6.

First, the round bar-shaped coating bar 100 is placed on the base layer BL, and then the surface of the coating bar 100 is coated with the blended coating solution.

Next, the coating bar 100 coated with the coating solution is moved at a constant speed in the horizontal direction (direction indicated by a red arrow in the drawing) while being in contact with the upper surface of the base layer BL, thereby forming a coating layer CL with a uniform thickness on the base layer BL.

Here, the thickness of the coating layer CL formed by the method described above can be controlled by adjusting the viscosity (concentration) of the blended coating solution, the surface pattern of the coating bar 100 (see FIG. 5), the moving speed (20 to 100 mm/sec) of the coating bar 100, and the weight of the coating bar 100.

The moving speed of the coating bar must be adjusted within an appropriate range to uniformly control the thickness of the coating layer. When the moving speed of the coating bar is slow (less than 20 mm/sec), the solution starts being dried from the starting point of the coating, resulting in uneven thickness. When the moving speed is faster than 100 mm/sec, the time for achieving a uniform thickness may not be enough due to the flowing of the coating solution on the surface of the coating.

Step d: The coating layer formed in the step c is heated and dried to remove the solvent (See FIG. 6). In this process, a smaller number of ion channels C than the number of ion channels in the base layer BL are formed in the coating layer CL. That is, m ion channels C are formed. Therefore, rectification characteristics in which ions flow well in a specific direction, i.e., from the n ion channels C formed in the base layer BL to the m ions channels C formed in the coating layer CL are imparted (S400).

That is, in this step, the base layer BL coated with the coating solution is gradually heated and dried on a hot plate 300 (see FIG. 6) in a temperature range of 15° C. to 300° C. for up to 24 hours.

According to one embodiment, the process of creating ion channels is explained as follows, assuming that perfluorosulfonic acid (PFSA) is used as the ionomer.

Perfluorosulfonic acid (PFSA) is a representative ion exchange resin component of cation exchange membranes and is commercially available under the product name “Nafion”. The perfluorosulfonic acid has a backbone of a perfluoroalkyl structure and a sidechain structure containing a sulfonic acid group.

The backbone serves as a skeleton that forms the shape of the polymer, and the sulfonic acid group in the side chain is ionized in water, becomes anionic, and performs an ion exchange function with cations or transfers ions.

The perfluorinated compound of the backbone is hydrophobic, and the side chain is hydrophilic due to the sulfonic acid group. Accordingly, in the dried state, the hydrophilic portion forms an ionic region.

At this time, as water (solvent) is absorbed by the polymeric compound, the water content increases and the ion regions expand and connects to each other to form network-shaped ion channels (with the membrane shape maintained, the water content of the ion exchange membrane is in the range of 20% to 50%).

In addition, the network-shaped ion channels are formed by nano-sized phase separation of hydrophobic regions and hydrophilic regions, and the crystalline array spacing of the hydrophobic regions and the array spacing of the hydrophilic regions are at the level of several nanometers.

The structure of the ion channels created in this way is cylindrical and has a very fine diameter. Since the ion channels are surrounded by anion functional groups, a very large electric force acts on the interior of the channels, and only cations are selectively transmitted by the electric force.

Therefore, as a result of the step, the ratio (n:m) of the number of ion channels C formed in the base layer BL and the number of ion channels formed in the coating layer CL is formed within a range of 10:1 to 100:1.

That is, the ratio of the numbers of ion channels C is controlled by adjusting the content ratio between the ionomer, which is a raw material of the ion exchange membrane, and the organic/inorganic mixture that can be dissolved and dispersed in the same solvent.

Referring to FIG. 4, the results of theoretical numerical analysis in a generalized model of a dual-layer structure consisting of a base layer BL and a coating layer CL reveal that when the ratio of the numbers of ion channels C changes from 9:9 to 1:9 to be asymmetric, the ratio of 2V current to −2V current (ion rectification phenomenon) increases, and the ratio of the anion current (i_{Cl-}) to the cation current (i_{K+}) is maintained at a low level (high ion selectivity).

### Examples

Referring to the following experimental example, it was confirmed that as the ratio (n:m) of the number of ion channels C formed in the base layer BL and the number of ion channels formed in the coating layer increases, the ion rectification characteristic increases proportionally.

### Experimental Example: Result of Evaluation of Characteristics of a Multilayered Ion Exchange Manufactured by the Present Disclosure

A multilayered ion exchange membrane with rectifying properties used in the present experiment was manufactured under the following conditions:
1) Structural design of rectifying ion exchange membrane
   Ratio of numbers of ion channels C: Variable
   Number of coating layers CL: 1
Thickness of base layer BL: 25 μm
Thickness of coating layer CL: about 1 μm
2) Formation of base layer of rectifying ion exchange membrane
   Nafion NR211 (substance name: perfluorosulfonic acid (PFSA)/type: ionomer (fluorine-based polymer)/use: formation of basal layer BL/state: in the form of a film with a thickness of 25.4 μm)
3) Control of the ratio of the numbers of ion channels C (content ratio of ionomer and mixture during blending)
   Ionomer; perfluorosulfonic acid (PFSA)/type: ionomer (fluorine-based polymer)/use: forming ion channels C in coating layer
   Mixture: poly(vinylidene fluoride-co-tri fluoroethylene (PVDF-TrFE)/type: mixture (fluorine-based polymer)/use: reducing the number ratio of ion channels C in the coating layer CL
   Solvent: N,N-Dimethylformamide (DMF)/use: mixed solvent for blending
   Content of solute (ionomer+mixture) in blended coating solution: 20 wt %
   Solute (PFSA: PVDF-TrFE) content ratio: 50:50, 40:60, 30:70, 20:80, 10:90, 1:99
4) Ion rectification characteristics evaluation results
   Detailed composition conditions and ion rectification characteristic evaluation results of the examples (Compositions 1 to 6) used in the experiment are shown in Table 1 and FIG. 6.

TABLE 1

| | Composition of | Solute weight | ion rectification |
|---|---|---|---|
| | coating solution | ratio | characteristics |
| | (PFSA/PVDF- | (PFSA:PVDF- | (current of +2 v/ |
| Classification | TrFE/DMF) | TrFE) | current of −2 v) |
| Comparative | Base layer only | — | 1.02 |
| Example | (no coating layer) | | |
| Composition 1 | 10 g/10 g/80 g | 50:50 | 0.07 |
| Composition 2 | 8 g/12 g/80 g | 40:60 | 1.57 |
| Composition 3 | 6 g/14 g/80 g | 30:70 | 2.98 |
| Composition 4 | 4 g/16 g/80 g | 20:80 | 4.61 |
| Composition 5 | 2 g/18 g/80 g | 10:90 | 7.47 |
| Composition 6 | 0.2 g/19.8 g/80 g | 1:99 | 12.36 |

The ion current flowing through the rectifying ion exchange membrane according to the present disclosure was measured in a potassium chloride (KCl) electrolyte solution with a concentration of 100 mol/L.
The ion rectification characteristics were evaluated by calculating the ratio of the forward current intensity to the reverse current intensity.
As a result, it was confirmed that the value of the ion rectification characteristic in the case where there is no coating layer CL (Comparative Example) is close to 1, and as the difference in the weight between the solutes increases, the value of the ion rectification characteristic (difference between forward current and reverse current) proportionally increased.
In other words, starting from Composition 2, an ion rectification phenomenon in which the forward current is 1.5 times higher than the reverse current is exhibited. That is, the rectifying properties effective for commercialization was shown in the solute weight ratio 40:60 or higher.

The present disclosure is not limited by the embodiments described above. Since the same effect can be obtained even when the detailed configuration, the number of components, and the arrangement of the components are changed, those who are ordinarily skilled in the art will appreciate that various additions, deletions, and modifications to or from the embodiments are possible without departing from scope of the technical idea of the present disclosure.

What is claimed is:

1. A method for manufacturing a multilayered ion exchange membrane with rectifying properties, the method comprising:
(a) forming a base layer having n ion channels inside an ion exchange resin comprising at least one of a fluorine-based polymer, a hydrocarbon-based polymer, or a hydrocarbon-based polymer partially substituted with fluorine;
(b) preparing a coating solution configured such that an ionomer and a mixture are uniformly dispersed in a solvent by blending the ionomer, the mixture, and the solvent in a predetermined ratio, wherein the ionomer comprises at least one of a fluorine-based polymer, a hydrocarbon-based polymer, or a hydrocarbon-based polymer partially substituted with fluorine, and the mixture suppresses creation of ion channels in the ionomer when mixed with the ionomer;
(c) forming at least one coating layer by applying the coating solution obtained in the step b on the base layer formed in the step a; and
(d) imparting rectifying properties of enabling ions to more easily flow in a specific direction by causing m ion channels to be formed in the coating layer in a process of removing the solvent through heat drying so that the ions are made to move from the base layer provided with a larger number of ion channels to the coating layer provided with a smaller number of ion channels, wherein the n is greater than the m.

2. The method according to claim 1, wherein the base layer in the step a is made of an ion exchange resin comprising at least one of fluorine-based polymers including perfluorosulfonic acid and perfluorocarboxylic acid, hydrocarbon-based polymers including polyphenylenes, polyetheretherketones, polyaryleneethers, polyimides, and polystyrenes, or hydrocarbon-based polymers partially substituted with fluorine.

3. The method according to claim 1, wherein the coating solution of the step b is formed by blending 0 to 10 wt % of the ionomer, 10 to 20 wt % of the mixture, and the remaining wt % of the solvent.

4. The method according to claim 3, wherein in the coating solution of the step b, the content of the ionomer is gradually reduced from 10 wt % to approximately 0 wt %, the content of the mixture is gradually increased from 10 wt % to 20 wt % in proportion to a reduction in the content of the ionomer, and the solvent accounts for the remaining wt %.

5. The method according to claim 1, wherein the coating solution of the step b comprises:
the ionomer comprising at least one of hydrocarbon-based polymers including polyphenylenes, polyetheretherketones, polyaryleneethers, polyimides, and polystyrenes, or hydrocarbon-based polymers partially substituted with fluorine; and
the mixture comprising at least one of fluorine-based polymers including polyvinylidene fluoride (PVDF) and polytetrafluoroethylene (PTFE), hydrocarbon-based polymers including polysulfone, polyetheretherketone, polyimide, and polystyrene, or hydrocarbon-based polymers partially substituted with fluorine.

6. The method according to claim 1, wherein the coating solution in the step b further comprises a crosslinking agent that is at least one of polydiacetylene (PDA), N,N′-methylene bisacrylamide (MBA), ethylene glycol diacrylate (EGDA), divinyl adipate (DVA), bis(2-acryl amido ethyl)disulfide (BAED), benzoyl peroxide (BPO), methylene diphenyl diisocyanate (MDI), and polyethyleneimine (PEI).

7. The method according to claim 1, wherein the solvent comprises at least one of water, ethanol, methanol, propyl alcohol, acetone, DMF, DMAc, and NMP.

8. The method according to claim 1, wherein as a result of the step d, a ratio (n:m) of the number of ion channels formed in the base layer to the number of ion channels formed in the coating layer is in a range of 10:1 to 100:1.

9. The method according to claim 1, wherein in the step c, the coating solution is first applied to a surface of a round bar, and the bar is then brought into contact with an upper surface of the base layer and is moved forward, so that the coating solution is transferred from the surface of the bar to the upper surface of the base layer.

10. The method according to claim 9, wherein the bar moves forward at a speed of 20 to 100 mm per second while being in contact with the upper surface of the base layer.

11. The method according to claim 1, wherein in the step d, the base layer coated with the coating solution is gradually heated and dried on a hot plate in a temperature range of 15° C. to 300° C. for up to 24 hours.

12. The method according to claim 1, wherein the base layer of the step a further comprises a film-forming binder comprising at least one of polyethylene, polypropylene, and polyvinyl chloride.

13. The method according to claim 1, wherein the base layer of the step a further comprises an inorganic additive comprising at least one of silica gel, carbon nanotube, aluminum oxide, and glass fiber.

14. The method according to claim 1, wherein the base layer of the step a further comprises a support film constituent material comprising at least one of polypropylene, polyethylene, PVC, PTFE, PVDF, and PET.

15. A multilayered ion exchange membrane with rectifying properties, the multilayered ion exchange membrane comprising:
a base layer having n ion channels inside an ion exchange resin comprising at least one of a fluorine-based polymer or a substituted polymer partially substituted with fluorine; and
a coating layer disposed on the base layer, comprising an ionomer and a mixture, and having m ion channels, wherein the m is less than the m, the ionomer comprises at least one of a fluorine-based polymer, a polystyrene-based polymer, or a hydrocarbon-based polymer partially substituted with fluorine, and the mixture suppresses creation of the ion channels formed in the ionomer when mixed with the ionomer.

16. The multilayered ion exchange membrane according to claim 15, wherein the mixture comprising at least one of fluorine-based polymers including polyvinylidene fluoride (PVDF) and polytetrafluoroethylene (PTFE), hydrocarbon-based polymers including polysulfone, polyetheretherketone, polyimide, and polystyrene, or hydrocarbon-based polymers partially substituted with fluorine.
